(19) United States
(12) Patent Application Publication
(10) Pub. No.: US 2010/0074217 A1
(43) Pub. Date: Mar. 25, 2010

(54) Method and Apparatus for Managing Sector of Base Station in Mobile Telecommunication Systems

(75) Inventors: Duk-Yong Kim, Gyeonggi-do (KR); Jung-Pil Lee, Gyeonggi-do (KR); Young-Chan Moon, Gyeonggi-do (KR); Jin-Chul Hwang, Gyeonggi-do (KR)

Correspondence Address: STORM LLP, BANK OF AMERICA PLAZA, 901 MAIN STREET, SUITE 7100, DALLAS, TX, 75202, US

(73) Assignee: KMW INC., Kyonggi-do (KR)

(21) Appl. No.: 12/517,095

(22) PCT Filed: Dec. 4, 2006
(86) PCT No.: PCT/KR06/05183

§ 371 Date: Jun. 1, 2009

(30) Foreign Application Priority Data
Dec. 1, 2006 (KR) 10-2006-0121062

(51) Int. Cl. H04W 72/04

(52) U.S. Cl. 370/330

(57) ABSTRACT

Disclosed is a method for operating sectors of a base station in a mobile telecommunication system. For this, the method includes the steps of: outputting, at a prescribed time period equal to T1, data, including alpha sector data, beta sector data, and gamma sector data, which is to be transmitted to a mobile station, in sequence and by sectors; dividing a frequency in a scheme of time division at a time period which equals either tα, tβ or tγ and which corresponds to the data length by the sector of data which is output in the outputting data, and carrying out a frequency assignment in sequence and by the sector. Accordingly, only relevant data is transmitted to a sector assigned the frequency, and a traffic variation of each sector can be met.

### TECHNICAL FIELD

The present invention relates to mobile telecommunication technology, and more particularly to a method and an apparatus for operating sectors of a base station in a mobile telecommunication system, in which frequency operation efficiency can be improved by varying the frequency assignment time set for each sector according to a traffic distribution of each sector, while performing time division frequency assignment by the sector of each base station.

### BACKGROUND ART

A scheme of existing cellular mobile telecommunications divides a service area into basic units called “Cells” and is separately operated in an omni cell scheme and a sector cell scheme. Herein, the omni cell scheme takes charge of communication of all cells by using one omni antenna. The sector cell scheme performs communications by dividing a cell into more than two sectors.

The omni cell scheme enables an FA to propagate in the form of a circle, as illustrated in FIG. 1, and takes charge of all the cells through the equipment of a base station.

Even though the omni cell scheme has merit in that a hand-off problem within a cell is not caused, the coverage of services is limited as antenna gain is small, and the same energy is delivered within all the cells regardless of a distribution of subscribers.

Namely, the omni cell scheme opens a wireless channel to all subscribers within a cell, and transmits/receives data. Accordingly, there exists an inefficiency which causes even data necessary to another person to be transmitted to each subscriber.

Hence, the omni cell scheme is advantageous in a area of low density of subscribers, but as the number of subscribers increase, the omni cell scheme additionally assigns the FA to solve a problem of insufficient capacity, or should divide a service area into sector cells for the purpose of installing more resources of hardware (i.e., channels) to solve a problem of insufficient capacity.

The sector cell scheme divides each cell area into more than two sectors to operate communications. For example, in a case of a system of k=1, where the same FA is assigned to each sector as illustrated in FIG. 2, the sector cell scheme installs three times more resources of hardware (i.e., channels) by the number of sectors, but can not obtain triple enlargement of capacity as compared with the omni cell scheme.

This is why the sector cell scheme does not have as much capacity enlargement effect as the division of each cell area wants to get, due to an interfering signal of an overlap area between the sectors and a soft hand-off problem.

An overlap between the sectors is physically caused by incompleteness of radiation characteristics of an antenna, and in order for a subscriber, who is in the overlap area, to be supported by a soft hand-off for selecting a sector, the subscriber should simultaneously connect to and maintain a call signal of an adjacent sector. On this account, the inefficiency is caused by a waste of wireless channels and a load of the equipment for supporting the soft hand-off.

For example, in a case of a system of k=3, where FAs including FA1, FA2, and FA3, which are different from one other, are assigned to each sector after a cell is divided into three sectors among sector cell schemes, as illustrated in FIG. 3, even though there exists no interference of the overlap area between the sectors and no soft hand-off, there are drawbacks in that a hard hand-off problem is incurred, and that even more RF resources are needed, as the FAs which are different from one other by at least the number of sectors are necessary.

Furthermore, the cell of the sector cell scheme is designed on the assumption that a traffic load of each sector is prescribed. Namely, it is problematic that load balancing cannot be accomplished, even though a specific sector is overloaded, since the traffic load that each sector can accommodate by each sector is fixed.

### DISCLOSURE OF INVENTION

### Technical Problem

Therefore, the present invention has been made in view of the above-mentioned problems. The first object of the present invention is to provide a method and an apparatus for operating sectors of a base station in a mobile telecommunication system, in which the frequency operation efficiency can be improved by performing a time division frequency assignment by the sector of each base station, as compared with the existing omni scheme or the existing sector operating scheme where frequency is fixedly assigned.

The second object of the present invention is to provide a method and an apparatus for operating sectors of a base station in a mobile telecommunication system, in which the frequency operation efficiency can be improved as compared with the existing omni scheme or the existing sector operating scheme, by assigning time division frequency by the sector of each base station. Therefore, the operation cost of the base station can be reduced.

The third object of the present invention is to provide a method and an apparatus for operating sectors of a base station in a mobile telecommunication system, in which interference among sectors is not caused by assigning time division frequency by the sector of each base station. Therefore, frequency operation efficiency can be improved.

The fourth object of the present invention is to provide a method and an apparatus for operating sectors of a base station in a mobile telecommunication system, in which assigning time division frequency by the sector of each base station resolves difficulty of the soft hand-off among sectors, corresponding to a drawback of the sector operating scheme of k=3. This enables the soft hand-off to improve the efficiency of the frequency operation.

The fifth object of the present invention is to provide a method and an apparatus for operating sectors of a base station in a mobile telecommunication system, in which variably assigning the frequency assignment time set for each sector according to a traffic distribution by sectors, can cope with a traffic variation by the sectors. Thus, load balancing can be achieved.

The sixth object of the present invention is to provide a method and an apparatus for operating sectors of a base station in a mobile telecommunication system, in which because the frequency operation capacity that the FA has can be concentrated on a specific sector and not on all cells, a data transfer rate can be increased for a subscriber who belongs to the specific sector, and transmission quality can be improved, as well.

### Technical Solution

According to an aspect of the present invention, there is provided a method for operating sectors of a base station in a mobile telecommunication system, including the steps of: outputting, at a prescribed time period equal to T1, data, including alpha sector data, beta sector data, and gamma sector data, which is to be transmitted to a mobile station, in sequence and by sectors; dividing a frequency in a scheme of time division at a time period equal to either tα, tβ tγ corresponding to the data length by the sector of data which is output in the outputting data, and carrying out a frequency assignment in sequence and by the sector; and wherein only relevant data is transmitted to a sector that has been assigned the frequency, and a traffic variation of each sector can be met.

According to another aspect of the present invention, there is provided an apparatus for operating sectors of a base station in a mobile telecommunication system, including: a time division frequency assigning unit for dividing a frequency in the scheme of time division at a time period which equals either tα, tβ or tγ and which corresponds to the data length by the sector of data, including alpha sector data, beta sector data, and gamma sector data, which is to be transmitted to a mobile station, within a prescribed time period which equals T1, and for outputting data simultaneously with a synchronizing signal at the time period which equals either tα, tβ or tγ and a switching unit for carrying out switching in synchronization with the synchronizing signal of the time division frequency assigning unit, dividing, in a scheme of time division, an output signal from the time division frequency assigning unit, and for delivering a time-divided signal to an antenna by each sector.

### Advantageous Effects

The merits and effects of the above-mentioned present invention will be described as follows.

The frequency operation efficiency can be improved by performing a time division frequency assignment by the sector of each base station, as compared with the existing omni scheme or the existing sector operating scheme, where frequency is fixedly assigned.

The frequency operation efficiency can be improved as compared with the existing omni scheme or the existing sector operating scheme, by performing a time division frequency assignment by the sector of each base station, and therefore, operation cost of the base station can be reduced.

Interference among sectors is not caused by performing a time division frequency assignment by the sector of each base station, and therefore, the frequency operation efficiency can be improved.

Performing a time division frequency assignment by the sector of each base station settles difficulty of the soft hand-off among sectors, corresponding to a drawback of the sector operating scheme of k=3, and enables the soft hand-off to improve the frequency operation efficiency.

Variably assigning the frequency assignment time set for each sector according to a traffic distribution by sectors can cope with a traffic variation by the sectors, and accordingly, load balancing can be achieved.

Because the frequency operation capacity that the FA has can be concentrated on a specific sector not on all cells, a data transfer rate can be increased for a subscriber who belongs to the specific sector, and transmission quality can be improved, as well.

### BRIEF DESCRIPTION OF THE DRAWINGS

The foregoing and other objects, features and advantages of the present invention will become more apparent from the following detailed description when taken in conjunction with the accompanying drawings in which:

FIG. 1 is a view illustrating a state of a sector assignment of an omni cell base station;

FIG. 2 is a view illustrating a state of assigning the same FA1 to each sector among sector cell schemes;

FIG. 3 is a view illustrating a state of assigning FAs different from one another to each sector among sector cell schemes;

FIG. 4 is a block diagram illustrating the sector operation equipment of a base station according to a first embodiment of the present invention;

FIG. 5 is a block diagram illustrating an output state of data by each functional unit shown in FIG. 4;

FIG. 6 is a view illustrating an assignment state by each sector at the time of time division frequency assignment by the sector according to a preferred embodiment of the present invention;

FIG. 7 is a block diagram illustrating an output state of data by each functional unit when data traffic crowds to an alpha sector in FIG. 4;

FIG. 8 is a block diagram illustrating the sector operation equipment of a base station according to a second embodiment of the present invention;

FIG. 9 is a block diagram illustrating another embodiment into which the second embodiment shown in FIG. 8 is transformed;

FIG. 10 is a view illustrating a state of a FA assignment of each sector according to an embodiment of the present invention;

FIG. 11 is a view illustrating a state of a FA assignment of each sector according to another embodiment of the present invention; and

FIG. 12 is a view illustrating a state of a FA assignment of each sector according to still another embodiment of the present invention.

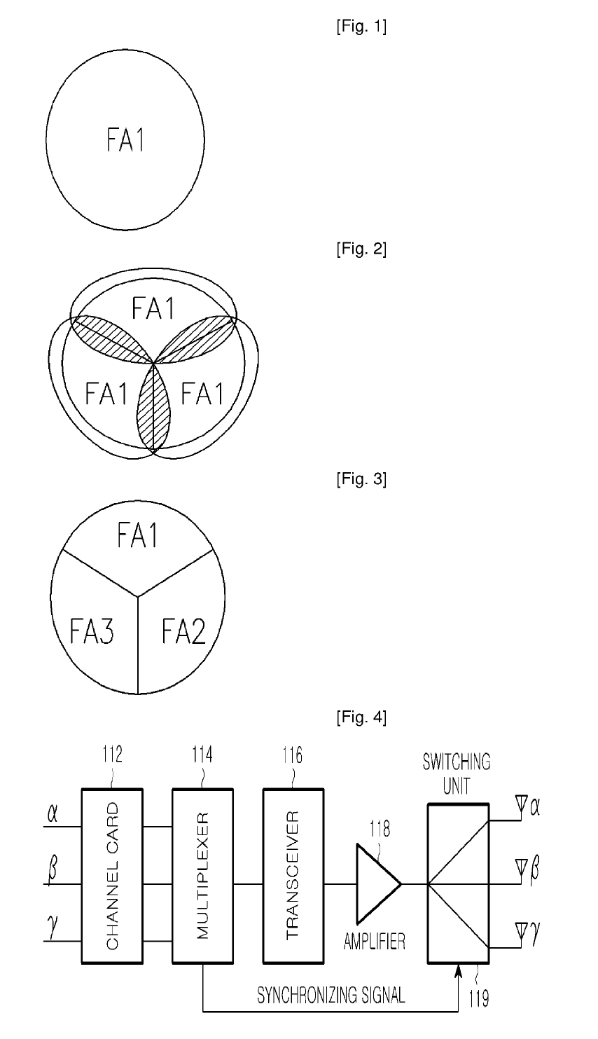

### BEST MODE FOR CARRYING OUT THE INVENTION

Reference will now be made in detail to the preferred embodiments of the present invention.

A method for operating sectors of a base station in a mobile telecommunication system, includes the steps of: outputting, at a prescribed time period equal to T1, data, including alpha sector data, beta sector data, and gamma sector data, which are to be transmitted to a mobile station, in sequence and by sectors; dividing a frequency in a scheme of time division at a time period equal to either tα, tβ or tγ corresponding to the data length by the sector of data which is output in the outputting data, and carrying out a frequency assignment in sequence and by the sector; providing a synchronizing signal C at a time period which equals either tα, tβ or tγ and which corresponds to the data length by the sector of data which is output in the outputting data; carrying out switching in synchronization with the synchronizing signal provided in the providing a synchronizing signal, dividing an output signal provided in the dividing a frequency in a scheme of time division, and delivering a time-divided signal to an antenna by each sector, will be disclosed.

### MODE FOR THE INVENTION

Hereinafter, preferred embodiments of the present invention will be described with reference to the accompanying drawings. The next description includes detailed and specified contents (e.g., units, components, devices, etc.) which are presented in support of more comprehensive perception of the present invention. In the following description of the present invention, a detailed description of known functions and configurations incorporated herein will be omitted when it may make the subject matter of the present invention rather unclear.

First, in a first embodiment of the present invention, a case of a three-sector system where the same FA (i.e., FA1) is assigned to each sector in order to offer services of communication will be described. In the manner of the omni cell scheme, the number of resources of hardware (i.e., channels) is one.

FIG. 4 is a block diagram illustrating the sector operation equipment of a base station according to a first embodiment of the present invention. As illustrated in FIG. 4, the sector operation equipment of the base station includes, a channel card 112 for providing, with the setting of time difference among sectors and at a prescribed time period equal to T1, data, including alpha sector data, beta sector data, and gamma sector data, which is to be transmitted to a mobile station (not shown); a multiplexer 114 for receiving data provided from the channel card 112, and for outputting the received data in sequence and at the prescribed time period equal to T1, simultaneously with a synchronizing signal at a time period which equals either tα, tβ or tγ and which corresponds to the data length by the sector of the received data; a transceiver 116 for converting an output signal, provided from the multiplexer 114, into a high frequency signal, and for providing the high frequency signal; an amplifier 118 for amplifying the high frequency signal from the transceiver 116, and for outputting an amplified signal; and a switching unit 119 for switching in synchronization with the synchronizing signal from the multiplexer 114, for dividing the amplified signal from the amplifier 118 in the scheme of time division, and for delivering a time-divided signal to an antenna by each sector.

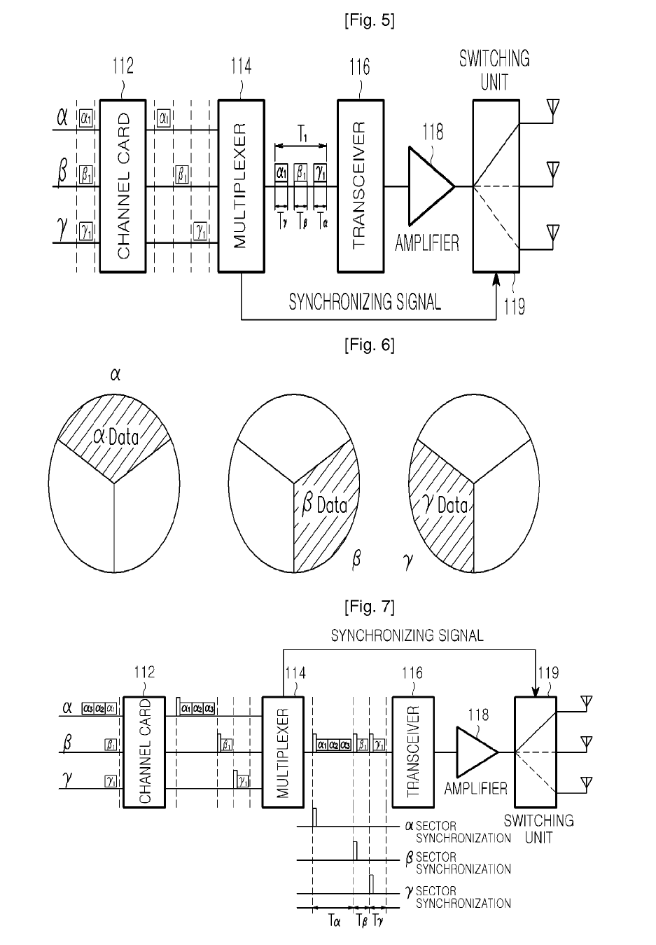

Hereinafter, an operation of the sector operation equipment illustrated in FIG. 4 will be described with reference to FIG. 5.

As illustrated in FIG. 5, the channel card 112 divides the received data by each sector in the scheme of time division at the prescribed time period T1, and outputs the time-divided signal with the setting of time difference among each sector in sequence. Namely, alpha sector data, beta sector data, and gamma sector data are not simultaneously output in the same time zone, and therefore, it is desirable that only data of any of the sectors is sequentially output. At this time, the prescribed time period T1 is specified in the range of time interval during which a transmission state of an audio signal or a data signal between the base station and a subscriber is not disconnected.

The multiplexer 114 receives each sector data provided from the channel card 112 with the setting of time difference among each sector in sequence, and outputs the received each sector data at the prescribed time period T1 in series, and in sequence, simultaneously with the synchronizing signal at the time period equal to either tα, tβ or tγ corresponding to the data length by the sector. Hereupon, the transceiver 116 converts the output signal from the multiplexer 114 into the high frequency signal, and outputs the high frequency signal. The high frequency signal provided from the transceiver 116 is amplified through the amplifier 118, and then the amplified signal is provided to the switching unit 119.

The switching unit 119, which has received the amplified signal from the amplifier 118, divides the amplified signal from the amplifier 118 in the scheme of time division while performing switching in synchronization with the synchronizing signal from the multiplexer 114, and delivers the time-divided signal to the antenna by each sector.

The above-mentioned operation results in the situation where one FA (i.e., FA1) is sequentially assigned to each sector, as illustrated in FIG. 6. Namely, the assignment is accomplished in order of an alpha sector, a beta sector, and a gamma sector.

At this time, because the switching unit 119 performs switching at the time period which equals either tα, tβ or tγ and which corresponds to the data length by the sector (i.e., a time period of the synchronizing signal from the multiplexer 114) in order to assign the FA (i.e., FA1) to each sector, only data corresponding to the alpha sector is transmitted to the alpha sector while assigning the FA1 to the alpha sector, and accordingly, no data is transferred to the remaining beta and gamma sectors.

Similarly, only data corresponding to the beta sector is transferred to the beta sector while the FA1 is assigned to the beta sector, and no data is transferred to the remaining alpha and gamma sectors. Likewise, only data corresponding to the gamma sector is transferred to the gamma sector while the FA1 is assigned to the gamma sector, and no data is transferred to the remaining alpha and beta sectors.

In this manner, other than the omni scheme, where the FA is assigned to all cells, since the frequency operation capacity that the FA is concentrated on one sector, frequency operation efficiency is improved, and it can reduce the operation cost of the base station. Furthermore, a data transfer rate can be increased for a subscriber who belongs to a specific sector, and transmission quality can be improved, as well. Besides, since the FA is not assigned to the beta and gamma sectors while the FA is assigned to the alpha sector, capacity reduction due to the interference between the sectors which has been incurred in the prior arts as illustrated in FIG. 2, is not caused.

Moreover, the three-sector scheme has been described in an embodiment of the present invention, but the present invention is not limited to this. Namely, it goes without saying that an embodiment of the present invention can be applied even to an N-sector scheme where the number of the sectors can be any number more than 2.

Meanwhile, as even more traffic crowds to a specific sector, for example, if more traffic crowds to the alpha sector, as illustrated in FIG. 7, data of the alpha sector would be increased among data by each sector provided from the channel card 112 during the predetermined time period T1, and it would make the data of the alpha sector increased more than usual, among data successively provided from the multiplexer 114.

Then, because the multiplexer 114 generates the synchronizing signal at the time period equal to either tα, tβ or tγ corresponding to the data length by the sector, among data which is being output, the time period of the synchronizing signal becomes longer by the length of the data of the alpha sector with respect to the data thereof after all.

As the time interval during which the switching unit 119 assigns the frequency to the alpha sector becomes larger in the end, since the switching unit 119 performs switching in synchronization with the synchronizing signal, the switching unit 119 is now automatically able to cope with the traffic variation by sectors. In other words, load balancing can be achieved.

In addition, it is usually required that the specification of the amplifier 118 satisfies requisites of a High Power Amp (HPA). Hence, the switching unit 119, which takes charge of switching the output signal of the amplifier 118, should be suitable for switching with high-power and high-speed.

In a case when the switching unit 119 is not capable of switching with high-power and high-speed, it is recommended that the switching unit 119 should be arranged at the front end, for a switch for high power is not necessarily required if the amplifier 118 switches pre-amplified signals.

However, in the case of a switching unit whose circuit arrangement is accomplished as mentioned above, an amplifier should be connected to an output end of each switching unit. Therefore, three amplifiers are required, and it should be noted that this causes an increase of cost to a user.

Next, in a second embodiment of the present invention, a case (i.e., k=3) where among sector cell schemes, mutually different FA such as FA1, FA2, and FA3, is assigned to three sectors in order to offer services of communication will be described.

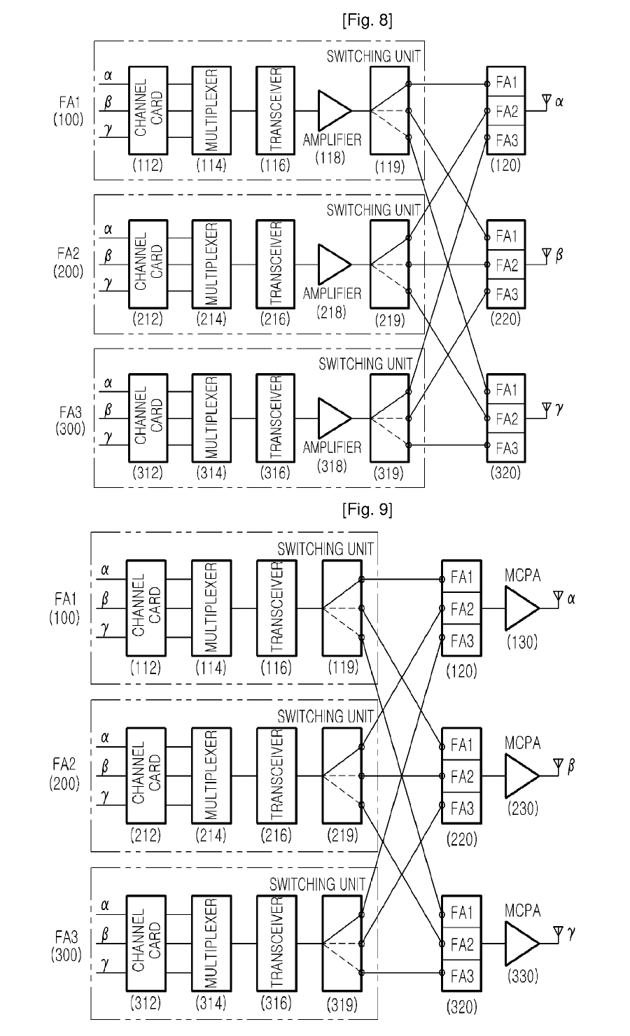

FIG. 8 is a block diagram illustrating the sector operation equipment of a base station according to a second embodiment of the present invention. As illustrated in FIG. 8, the sector operation equipment of a base station includes time division frequency assigning units by each FA, namely, first, second, and third time division frequency assigning units 100, 200, and 300.

The first, second, and third time division frequency assigning units 100, 200, and 300 include, channel cards 112, 212, and 312 for providing, with the setting of a time difference among the sectors and at a prescribed time period equal to T1, data, including alpha sector data, beta sector data, and gamma sector data, which is to be transmitted to a mobile station (not shown), respectively; multiplexers 114, 214, and 314 for receiving data provided at a predetermined time period T1 from the channel cards 112, 212, and 312, and for outputting the received data in sequence, simultaneously with synchronizing signals at a time period which equals either tα, tβ or tγ and which corresponds to the data length by the sector of the received data; transceivers 116, 216, and 316 for converting output signals, provided from the multiplexers 114, 214, and 314, into high frequency signals, and for providing the high frequency signals; amplifiers 118, 218, and 318 for amplifying the high frequency signals from the transceivers 116, 216, and 316, and for outputting amplified signals; and switching units 119, 219, 319 for switching in synchronization with the synchronizing signals (display of synchronizing signals is omitted) from the multiplexers 114, 214, and 314, for dividing the amplified signals from the amplifiers 118, 218, and 318 in the scheme of time division, for delivering time-divided signals to an antenna by each sector, and for outputting a relevant FA, such as FA1, FA2, and FA3.

Further, the sector operation equipment of the base station is equipped with first, second, and third channel combiners 120, 220, and 320, which receive relevant sector data by the FA from the first, second, and third time division frequency assigning units 100, 200, and 300, then combine the received relevant sector data, and lastly, deliver combined sector data to pertinent antennas.

Hereinafter, an operation of the sector operation equipment shown in FIG. 8, will be described. The second embodiment illustrated in FIG. 8 corresponds to the extension of the above-stated first embodiment, and a fundamental configuration is the same as the configuration of the first embodiment. Herein, a number of FAs can be adopted, provided the multiple channel combiners 120, 220, and 320 are equipped to combine the plurality of FAs.

Each of the first, second, and third time division frequency assigning units 100, 200, and 300 has the same operation as the aforesaid operation of the first embodiment, and each receives a signal of each of the FA1, FA2, and FA3, in order to process the received signal.

Namely, each of the channel cards 112, 212, and 312 divides the received data by each sector in the scheme of time division at the prescribed time period T1, and each outputs the time-divided signal with the setting of time difference among each sector and in sequence.

Each of the multiplexers 114, 214, and 314 receives each sector data, provided at the prescribed time period T1, namely, with the setting of time difference among each sector, in sequence, from the channel cards 112, 212, and 312, and each outputs the received each sector data at the prescribed time period T1, in series, and in sequence, simultaneously with the synchronizing signal at the time period equal to either tα, tβ or tγ corresponding to the data length by the sector.

Each of the transceivers 116, 216, and 316 converts the output signal from each of the relevant multiplexers 114, 214, and 314 into the high frequency signal, and outputs the high frequency signal. Each of the amplifiers 118, 218, and 318 amplifies the high frequency signal provided from each of the relevant transceivers 116, 216, and 316, and outputs the amplified signal. Each of the switching units 119, 219, 319, which has received the amplified signal from each of the amplifiers 118, 218, and 318, divides the amplified signal from each of the amplifiers 118, 218, and 318 in the scheme of time division while performing switching in synchronization with the synchronizing signal from each of the relevant multiplexers 114, 214, and 314, and outputs the time-divided signal. Then, in order to process mutually different three FA signals while combining them, each of the channel combiners 120, 220, and 320 is combined to the relevant antenna by each sector.

Accordingly, the first switching unit 119, included in the first time division frequency assigning unit 100 which uses the FA1, delivers the switched data signal by sectors, to a first side terminal FA1 of each of the first, second, and third channel combiners 120, 220, and 320, connected to the antenna by each sector.

Likewise, the second switching unit 219, included in the second time division frequency assigning unit 200 which uses the FA2, delivers the switched data signal by the sectors to a second side terminal FA2 of each of the first, second, and third channel combiners 120, 220, and 320, connected to the antenna by each sector. Furthermore, the third switching unit 319, included in the third time division frequency assigning unit 300 which uses the FA3, delivers the switched data signal by the sectors to a third side terminal FA3 of each of the first, second, and third channel combiners 120, 220, and 320, connected to the antenna by each sector.

In this manner, the first channel combiner 120 receives data of the alpha sector by each FA provided from the first, second, and third switching units 119, 219, and 319, combines the received data of the alpha sector, and outputs combined data through an antenna of the alpha sector.

Similarly, the second channel combiner 220 receives data of the beta sector by each FA provided from the first, second, and third switching units 119, 219, and 319, combines the received data of the beta sector, and outputs combined data through an antenna of the beta sector. The third channel combiner 320 receives data of the gamma sector by each FA provided from the first, second, and third switching units 119, 219, and 319, combines the received data of the gamma sector, and outputs combined data through an antenna of the gamma sector.

The first, second, and third channel combiners 120, 220, and 320 can be replaced with channel filters, etc., which perform the same functions.

According to an operation of the second embodiment of the present invention, configured in this manner, variably assigning the frequency assignment time set for each sector according to a traffic distribution of each sector can cope with the traffic variation by the sectors, and accordingly, load balancing can be achieved. Then, each FA can be either independently and variably assigned, or synchronously and variably assigned.

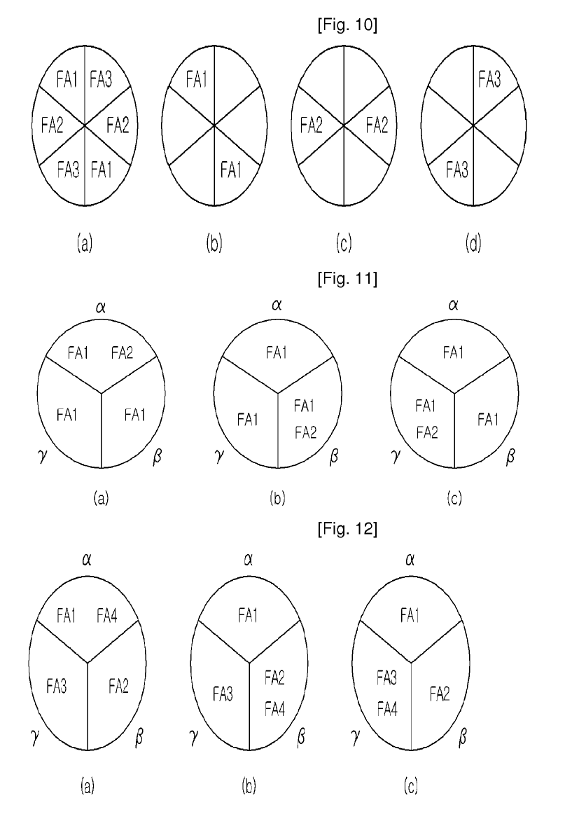

Meanwhile, to describe an example applied to a six-sector scheme, as illustrated in FIG. 10(A), a cell divided into six sectors is classified into 2 parts by the three sectors, and then, time division assignment is accomplished per each sector by using the method of the present invention. At this time, a pair of the same FAs is so assigned that they may face each other.

Namely, as illustrated in FIGS. 10 (B), (C), and (D), the FA1 is first assigned counterclockwise in one part, and is then assigned clockwise in the remaining two parts.

If operating in this manner, the time division assignment can be achieved without interference due to overlap among sectors. In addition, as the range of the sector assigned the FA becomes narrower, capacity enlargement can be achieved in a state where frequency operation efficiency is desirably maintained.

Meanwhile, it is usually required that the specification of each of the amplifiers 118, 218, and 318 satisfies requisites of a High Power Amp (HPA) having high capacity. Hence, the switching units 119, 219, and 319, which respectively take charge of switching the output signals of the amplifiers 118, 218, and 318, should be suitable for switching with high-power and high-speed.

In a case when the switching units 119, 219, and 319 are not capable of switching with high-power and high-speed, it is recommended that the switching units 119, 219, and 319 should be arranged between the channel combiners 120, 220, and 320 and the antennas (as shown in FIG. 9), for switches for high power are not necessarily required if the amplifiers 118, 218, and 318 switch pre-amplified signals.

However, since amplifiers installed at a back end of the channel combiners 120, 220, and 320 should be Multi-Channel Power Amp (MCPA), it should be noted that this causes an increase of cost to a user.

Moreover, the system of the three-sector scheme has been described in the second embodiment of the present invention, but the present invention is not limited to this. Namely, it goes without saying that an embodiment of the present invention can be applied even to an N-sector scheme where the number of the sectors can be any number more than 2.

In addition, various changes of application in form and details may be made therein according to a state of a present assignment of frequency in the present invention. For example, as illustrated in FIGS. 11 (A), (B), and (C), it is possible to carry out the time division frequency assignment by the sector with respect to other FA, as in the present invention, in a state where the same FA is fixedly assigned to each sector.

Furthermore, as illustrated in FIGS. 12 (A), (B), and (C), it is possible to carry out the time division frequency assignment by the sector with respect to other FA, as in the present invention, in a state where mutually different FAs are fixedly assigned to each sector in the three-sector system.

In this manner, no matter what state the frequency may be assigned at present, if the present invention can be applied, the frequency operation ability can be used most efficiently.

As above-stated, the configuration and operation of the method and apparatus for operating the sectors of the base station in the mobile telecommunication system according to the preferred embodiments of the present invention can be accomplished. While the invention has been shown and described with reference to a certain preferred embodiment thereof, it will be understood by those skilled in the art that various changes in form and details may be made therein without departing from the spirit and scope of the invention. Therefore, the spirit and scope of the present invention must be defined not by described embodiments thereof but by the appended claims and equivalents of the appended claims.

### INDUSTRIAL APPLICABILITY

The technology of the present invention is applicable to the operation of sectors of a base station.

1. A method for operating sectors of a base station in a mobile telecommunication system, the method comprising the steps of:
carrying out a time division frequency assignment with respect to each sector in sequence and at a prescribed time period equal to T1; and
variably assigning the frequency assignment time to each sector according to a traffic distribution of each sector.

2. A method for operating sectors of a base station in a mobile telecommunication system, the method comprising the steps of:
dividing a frequency in a scheme of time division at a time period which equals either tα, tβ or tγ and which corresponds to the data length by the sector of data, including alpha sector data, beta sector data, and gamma sector data, which is to be transmitted to a mobile station within a prescribed time period equal to T1, and carrying out a frequency assignment;
carrying out the frequency assignment in sequence and by the sector; and
transmitting only relevant data to a sector assigned the frequency, and coping with a traffic variation of the sector.

3. A method for operating sectors of a base station in a mobile telecommunication system, the method comprising the steps of:
(1) outputting, at a prescribed time period equal to T1, data, including alpha sector data, beta sector data, and gamma sector data, which is to be transmitted to a mobile station, in sequence and by sectors; and
(2) dividing a frequency in a scheme of time division at a time period which equals either tα, tβ or tγ and which corresponds to the data length by the sector of data which is output in step (1), and carrying out a frequency assignment in sequence and by the sector,
wherein only relevant data is transmitted to a sector assigned the frequency, and a traffic variation of each sector can be met.

4. A method for operating sectors of a base station in a mobile telecommunication system, the method comprising the steps of:
(1) outputting, at a prescribed time period equal to T1, data, including alpha sector data, beta sector data, and gamma sector data, which is to be transmitted to a mobile station, in sequence and by sectors;
(2) dividing a frequency in a scheme of time division at a time period equal to either tα, tβ or tγ corresponding to the data length by the sector of data which is output in step (1), and carrying out a frequency assignment in sequence and by the sector;
(3) providing a synchronizing signal C at a time period which equals either tα, tβ or tγ and which corresponds to the data length by the sector of data which is output in step (1); and
(4) carrying out switching in synchronization with the synchronizing signal provided in step (3), dividing an output signal provided in step (2) in a scheme of time division, and delivering a time-divided signal to an antenna by each sector, wherein only relevant data is transmitted to a sector assigned the frequency, and a traffic variation of each sector can be met.

5. A method for operating sectors of a base station in a mobile telecommunication system, the method comprising the steps of:
(1) outputting, with the setting of time difference among each sector and at a prescribed time period equal to T1, data, including alpha sector data, beta sector data, and gamma sector data, which is to be transmitted to a mobile station;
(2) receiving the data which is output in step (1), and providing the received data at a prescribed time period equal to T1, by sectors, and in sequence;
(3) carrying out a frequency assignment at a time period which equals either tα, tβ or tγ and which corresponds to the data length by the sector of data which is output in step (2), and carrying out the frequency assignment in sequence and by the sector;
(4) providing a synchronizing signal at a time period which equals either tα, tβ or tγ and which corresponds to the data length by the sector of the data which is output in step (2); and
(5) carrying out switching in synchronization with the synchronizing signal provided in step (4), dividing an output signal provided in step (3) in a scheme of time division, and delivering a time-divided signal to an antenna by each sector.

6. A method for operating sectors of a base station in a mobile telecommunication system, the method comprising the steps of:
(1) outputting, at a prescribed time period equal to T1, data, including alpha sector data, beta sector data, and gamma sector data, which is to be transmitted to a mobile station, in sequence and by sectors;
(2) dividing a frequency in a scheme of time division at a time period equal to either tα, tβ or tγ corresponding to the data length by the sector of data which is output in step (1), and carrying out a frequency assignment in sequence and by the sector;
(3) providing a synchronizing signal C at a time period which equals either tα, tβ or tγ and which corresponds to the data length by the sector of data which is output in step (1);
(4) carrying out switching in synchronization with the synchronizing signal provided in step (3), dividing an output signal provided in step (2) in a scheme of time division, and delivering a time-divided signal to an antenna by each sector; and
(5) combining only FA signals corresponding to a specific sector among multiple FA signals provided through the process of steps (1) to (4), and transferring a combined signal to an antenna of the relevant sector,
wherein only relevant data is transmitted to a sector assigned the frequency, and a traffic variation of each sector can be met.

7. The method as claimed in any of claims 1 to 6, wherein the prescribed time period equal to T1 is specified in the range of time interval during which the signal transmission between the base station and a subscriber is not disconnected.

8. The method as claimed in any of claims 2 to 6, which further comprises a step of converting, into a high frequency signal, a frequency which is assigned at the time period which equals either tα, tβ or tγ and which corresponds to the data length by the sector of the data.

9. The method as claimed in claim 8, which further comprises a step of amplifying a signal following the converting into a high frequency signal, or following the switching.

10. An apparatus for operating sectors of a base station in a mobile telecommunication system, the apparatus comprising:
a time division frequency assigning unit for dividing a frequency in the scheme of time division at a time period which equals either tα, tβ or tγ and which corresponds to the data length by the sector of data, including alpha sector data, beta sector data, and gamma sector data, which is to be transmitted to a mobile station, within a prescribed time period which equals T1, and for outputting data simultaneously with a synchronizing signal at the time period which equals either tα, tβ or tγ and
a switching unit for carrying out switching in synchronization with the synchronizing signal of the time division frequency assigning unit, dividing, in a scheme of time division, an output signal from the time division frequency assigning unit, and for delivering a time-divided signal to an antenna by each sector.

11. The apparatus as claimed in claim 10, wherein the time division frequency assigning unit comprises:
a channel card for providing, with the setting of a time difference among the sectors and at a prescribed time period equal to T1, data, including alpha sector data, beta sector data, and gamma sector data, which is to be transmitted to a mobile station;
a multiplexer for receiving data provided from the channel card, and for outputting the received data in sequence and at the prescribed time period equal to T1, simultaneously with a synchronizing signal at a time period which equals either tα, tβ or tγ and which corresponds to the data length by the sector of the data; and
a transceiver for converting an output signal, provided from the multiplexer, into a high frequency signal, and for providing the high frequency signal.

12. An apparatus for operating sectors of a base station in a mobile telecommunication system, the apparatus comprising:
a number of time division frequency assigning units; and
a number of channel combining units for receiving only data corresponding to a specified sector of specific FA from the number of time division frequency assigning units, for combining the received data, and for delivering combined data to relevant antennas,
wherein each of the time division frequency assigning unit comprises:
a channel card for providing, with the setting of a time difference among the sectors and at a prescribed time period equal to T1, data, including alpha sector data, beta sector data, and gamma sector data, which is to be transmitted to a mobile station;
a multiplexer for receiving data provided at the prescribed time period equal to T1 from the channel card, and for outputting the received data in sequence, simultaneously with a synchronizing signal at a time period which equals either tα, tβ or tγ and which corresponds to the data length by the sector of the data;
a transceiver for converting an output signal, provided from the multiplexer, into a high frequency signal, and for providing the high frequency signal; and
a switching unit for switching in synchronization with the synchronizing signal from the multiplexer, for dividing the high frequency signal provided from the transceiver in a scheme of time division, and for providing a time-divided signal.

13. The apparatus as claimed in any of claims 10 to 12, wherein the prescribed time period equal to T1 is specified in the range of time interval during which the signal transmission between the base station and a subscriber is not disconnected.

14. The apparatus as claimed in any of claims 10 to 12, which further comprises an amplifier for amplifying a signal, arranged at a front end of the switching unit or at a back end of the channel combining unit.

15. The apparatus as claimed in claim 14, wherein the switching unit corresponds to a high-power and high-speed switch, in a case of being equipped with the amplifier arranged at the front end of the switching unit.

16. The apparatus as claimed in any of claims 10 to 12, wherein the time division sector operation apparatus of the mobile telecommunication system, has the number of the sectors corresponding to a number more than 2.
